(19) United States
(12) Patent Application Publication
(10) Pub. No.: US 2004/0213467 A1
(43) Pub. Date: Oct. 28, 2004

(54) Image processing apparatus

(75) Inventors: Yoshinobu Tanaka, Tokyo (JP); Akira Ueno, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 10/826,342

(22) Filed: Apr. 19, 2004

(30) Foreign Application Priority Data
Apr. 23, 2003 (JP) 2003-117784

(51) Int. Cl. G06K 9/36; G06K 9/32

(52) U.S. Cl. 382/233; 382/298

(57) ABSTRACT

Disclosed herein is an image processing apparatus taking N×M pixels (N, M being a natural number of 2 or more) as one block, for processing image data consisting of a plurality of blocks by the unit block, including: a first resizing means for resizing the image data in a first direction; a line storage means capable of storing at least image data corresponding to one line along the first direction of the image data outputted from the first resizing means; and a second resizing means for resizing the image data outputted from the first resizing means in a second direction intersecting the first direction, the second resizing means acquiring image data of adjacent block from the line storage means.

This application claims benefit of Japanese Patent Application No. 2003-117784 filed in Japan on Apr. 23, 2003, the contents of which are incorporated by this reference.

### BACKGROUND OF THE INVENTION

The present invention relates to image processing apparatus taking N×M pixels (N, M being a natural number of two or more) as one block so as to resize image data consisting of a plurality of blocks by the block as a unit, and more particularly it relates to an image processing apparatus in which the resizing is effected before or after encoding/decoding.

Among the generally used techniques for efficiently encoding/decoding image data are the methods by the JPEG (Joint Photographic Experts Group) and the MPEG (Moving Picture Experts Group). The methods of JPEG or MPEG uses block as a unit in effecting various processing. FIG. 1 shows the relation between an image frame and blocks where one frame consisting of A×B pixels is divided into unit blocks each of 8×8 pixels so that the processings for example of orthogonal transformation and inverse orthogonal transformation are effected for each unit block.

The processing by the unit block as described is not suitable for a resizing such as an enlargement or reduction of image, though it is suitable for the encoding and decoding of image data in the JPEG, MPEG or the like.

A description will now be given by way of FIGS. 2A and 2B with respect to the resizing by the unit block. FIG. 2A shows blocks of 8 by 8 pixels, and FIG. 2B is an enlargement of a peripheral portion of block (in the dotted circle) of the 8×8 pixel block. Denoted by numerals 101 to 104 are the inputted pixels before the resizing of which the pixels 101 and 102 are located within block (I, J-1) and pixels 103 and 104 are located within block (I,J). Numeral 105 denotes the pixel to be outputted after the resizing, which is located within block (I,J). The output pixel 105 is obtained from an interpolating operation using the input pixels 101 to 104. In this manner, the resizing operation of a peripheral portion of block requires pixel information of a plurality of blocks.

Generally, therefore, resizing techniques by frame as the unit are mostly used in the resizing, though block-by-block processing is effected in the encoding and decoding. FIG. 3 is a block diagram showing construction of a conventional image processing apparatus which is characterized in the resizing processing by the frame. A JPEG decoder 111 decodes the JPEG code data to output image data by the block of 8×8 size. The outputted image data are stored to a memory 114 capable of storing image data of one frame via a memory controller 113. A resizing circuit 112 acquires image data from the memory 114 via the memory controller 113. The resizing circuit 112 effects a resizing frame by frame, and the image data after the resizing are stored to the memory 114 again via the memory controller 113. With the above described technique, the resizing can be effected after once storing the image data decoded according to the JPEG to the memory 114 to restore one frame of image.

On the other hand, proposals have been made also concerning the resizing using block as a unit. For example, a technique therefor is disclosed in Japanese Patent application Laid-Open Hei-11-53532. FIG. 4 is a block diagram showing an example of construction of a conventional image processing apparatus which is characterized in the block-by-block resizing. A JPEG decoder 121 decodes JPEG code data to output image data by the block of 8×8 size. Of the image data decoded at the JPEG decoder 121, the image data of the lowest line of block is stored to a line memory 122 having a capacity corresponding to one line. Further, the image data of the rightest column of block is stored to a buffer 123 having a capacity corresponding to eight pixels. A resizing circuit 124 acquires image data of adjacent blocks from the line memory 122 and buffer 123 to effect resizing. The image data resized at the resizing circuit 124 are written to memory 126 via a memory controller 125.

FIG. 5 illustrates a technique for acquiring the adjacent block data in the above described conventional example. Supposing block (I,J) as the block currently being processed, the image data of the lowest line of block (I,J-1) adjoining the upper side thereof is acquired from the line memory 122, and the image data of the rightest column of block (I-1,J) adjoining the left side thereof is acquired from the buffer 123. According to such prior-art technique, the block-by-block resizing becomes possible, since image data of adjacent blocks are acquired from the line memory 122 and buffer 123 to effect the resizing.

### SUMMARY OF THE INVENTION

It is an object of the present invention to provide an image processing apparatus for effecting a block-by-block resizing in which the capacity of line memory can be reduced as compared to the prior-art technique.

In a first aspect of the invention, there is provided an image processing apparatus taking N×M pixels (N, M being a natural number of 2 or more) as one block, for processing image data consisting of a plurality of blocks by the unit block, including: a first resizing means for resizing the image data in a first direction; a line storage means capable of storing at least image data corresponding to one line along the first direction of the image data outputted from the first resizing means; and a second resizing means for resizing the image data outputted from the first resizing means in a second direction intersecting the first direction. The second resizing means is formed so as to acquire image data of adjacent block from the line storage means.

In a second aspect of the invention, the image processing apparatus according to the first aspect further includes a decoding means for decoding compressed and encoded image data block by block, the image data decoded at the decoding means being subjected to resizing.

In a third aspect of the invention, the image processing apparatus according to the first aspect further includes an encoding means for compressing and encoding image data block by block, the resized image data being compressed and encoded at the encoding means.

In a fourth aspect of the invention, the first resizing means in the image processing apparatus according to the first aspect resizes the image data based on a thinning out in the first direction.

In a fifth aspect of the invention, the first resizing means in the image processing apparatus according to the first aspect resizes the image data based on an added average in the first direction.

In a sixth aspect of the invention, the image processing apparatus according to the first aspect further includes a pixel storage means capable of storing at least image data corresponding to the number of pixels of block in the second direction of the N×M pixel block, the first resizing means acquiring image data of adjacent block from the pixel storage means.

In a seventh aspect of the invention, the pixel storage means in the image processing apparatus according to the sixth aspect is capable of storing image data corresponding to the number of pixels of block in the second direction of the N×M pixel block, the first resizing means effecting resizing based on 2-point interpolation in the first direction.

In an eighth aspect of the invention, the pixel storage means in the image processing apparatus according to the sixth aspect is capable of storing image data corresponding to three times the number of pixels of block in the second direction of the N×M pixel block, the first resizing means effecting resizing based on 4-point interpolation in the first direction.

In a ninth aspect of the invention, the line storage means in the image processing apparatus according to the first aspect is capable of storing image data corresponding to one line in the first direction of the image data resized at the first resizing means, the second resizing means effecting resizing based on 2-point interpolation in the second direction.

In a tenth aspect of the invention, the line storage means in the image processing apparatus according to the first aspect is capable of storing image data corresponding to three lines in the first direction of the image data resized at the first resizing means, the second resizing means effecting resizing based on 4-point interpolation in the second direction.

In an eleventh aspect of the invention, the image processing apparatus according to the first aspect further includes a first through resizing means capable of causing the resizing in the first direction to be through without a processing operation.

In a twelfth aspect of the invention, the image processing apparatus according to the first or eleventh aspect further includes a second through resizing means capable of causing the resizing in the second direction to be through without a processing operation.

In a thirteenth aspect of the invention, the line storage means in the image processing apparatus according to the first aspect has a capacity corresponding to a display region of an external display apparatus.

### BRIEF DESCRIPTION OF THE DRAWINGS

FIG. 1 shows the relation between an image frame and unit blocks.

FIGS. 2A and 2B show a block formed of 8 by 8 pixels and a peripheral portion of block in an enlarged manner, respectively.

FIG. 3 is a block diagram showing an example of the construction of a conventional image processing apparatus where resizing is effected frame by frame.

FIG. 4 is a block diagram showing an example of the construction of a conventional image processing apparatus where resizing is effected block by block.

FIG. 5 illustrates a technique for acquiring adjacent block data in the conventional example shown in FIG. 4.

FIG. 6 is a block diagram showing a first embodiment of the image processing apparatus according to the invention.

FIG. 7 shows an example of the resizing processing.

FIGS. 8A to 8D illustrate resizing techniques.

FIGS. 9A and 9B show block sizes before and after the horizontal resizing in the first embodiment shown in FIG. 6.

FIG. 10 is a block diagram showing a modification of the first embodiment shown in FIG. 6.

FIG. 11 is a block diagram showing an image processing apparatus according to a second embodiment of the invention.

FIG. 12 illustrates the manner of storage to the buffers in the second embodiment shown in FIG. 11.

FIG. 13 is a block diagram showing an image processing apparatus according to a third embodiment of the invention.

FIG. 14 is a block diagram showing an image processing apparatus according to a fourth embodiment of the invention.

FIGS. 15A to 15D each show an example of the block-by-block data output sequence and block size in respective embodiments of the invention.

### DESCRIPTION OF THE PREFERRED EMBODIMENTS

### First Embodiment

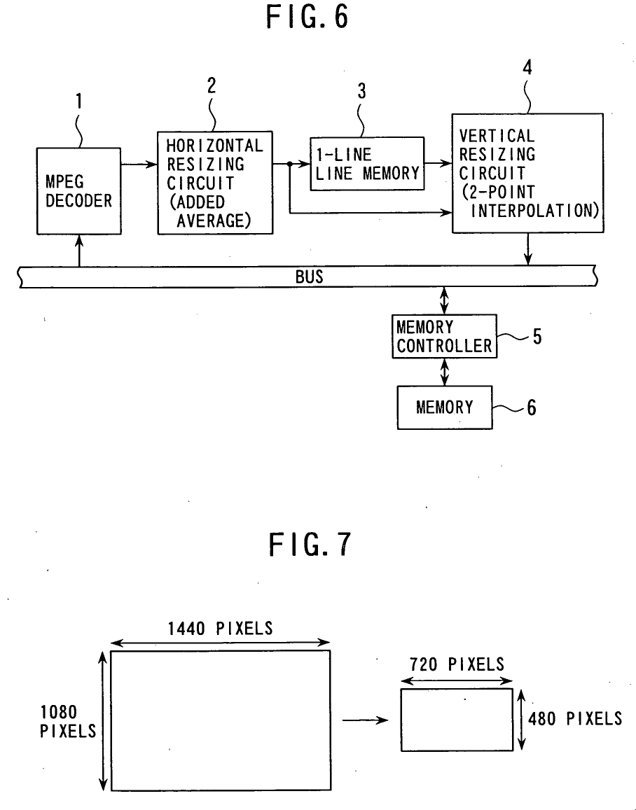

An embodiment of the invention will now be described. FIG. 6 is a block diagram showing construction of a first embodiment of the image processing apparatus according to the invention. FIG. 6 includes: 1, MPEG decoder for decoding the MPEG code data to output image data by the block of 8×8 pixel size; 2, a horizontal resizing circuit for horizontally resizing image data outputted block by block from the MPEG decoder 1; 3, a line memory having a capacity corresponding to one line, for storing image data of the lowest line of block of the output data from the horizontal resizing circuit 2; 4, a vertical resizing circuit for effecting resizing in the vertical direction by using the output data from the horizontal resizing circuit 2 and image data stored to the line memory 3; 5, a memory controller; and 6, a memory.

FIG. 7 illustrates an example of the manner of resizing in the present embodiment. In the following description, it is supposed that the image size outputted from the MPEG decoder 1 is 1440 by 1080 pixels, and the image size to be obtained at the end is 720 by 480 pixels.

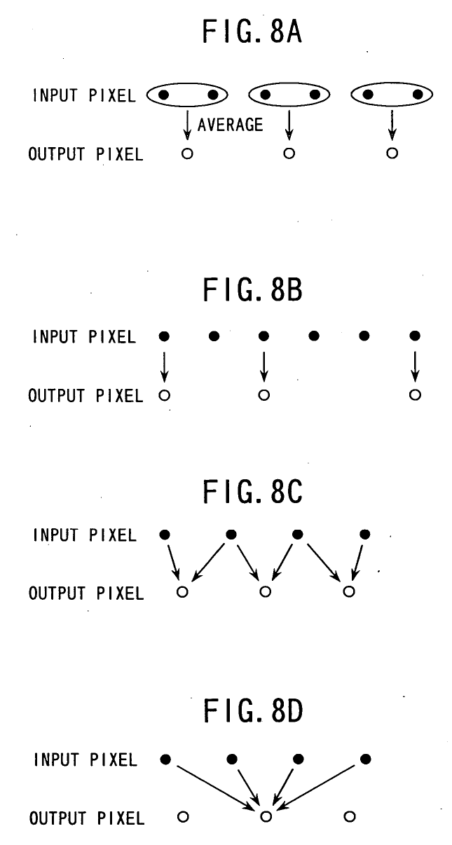

A description will now be given by way of FIG. 6 with respect to the operation of the present embodiment. The MPEG decoder 1 decodes MPEG code data and outputs image data block by block. The horizontal resizing circuit 2 resizes the image data outputted from the MPEG decoder 1 in the horizontal direction. At this time, if, as shown in FIG. 7, the output image size from the MPEG decoder 1 is 1440×1080 pixels and the image size to be obtained at the end is 720 ×480, the output image size from the horizontal resizing circuit 2 becomes 720×1080 pixels. Examples of the horizontal resizing technique include: a technique for outputting an average of a number of adjacent pixels (added average) as shown in FIG. 8A; and a technique of simply thinning out pixels (simple thinning-out/insertion) as shown in FIG. 8B.

Of the image data after the resizing processing at the horizontal resizing circuit 2, the data of the lowest line in the block are stored to the line memory 3. At this time, since the number of pixels after the resizing in the horizontal direction is 720 pixels, the line memory 3 is to have a capacity capable of storing 720 pixels.

At the vertical resizing circuit 4, the image data resized to 720×1080 pixel size at the horizontal resizing circuit 2 is vertically resized to 720×480 pixel size. An example of the vertical resizing technique is based on 2-point interpolation as shown in FIG. 8C. In the case where pixel information of adjacent block is necessary as for a peripheral portion of block, the vertical resizing is effected by using the data stored to the line memory 3. It should be noted that the processing method based on 4-point interpolation as shown in FIG. 8D is among other methods for resizing. This will be described later. The image data resized at the vertical resizing circuit 4 is stored to the memory 6 by way of the memory controller 5.

Based on the above processing, 1440×1080 size image data from the MPEG decoder 1 can be resized block by block to obtain 720×480 size image data. According to the previously shown conventional example, a capacity of line memory corresponding to 1440 pixels is necessary due to the fact that the input data is stored to the line memory. According to the present embodiment, by contrast, a capacity of line memory corresponding to 720 pixels suffices, since the storing to the line memory is effected after the horizontal resizing.

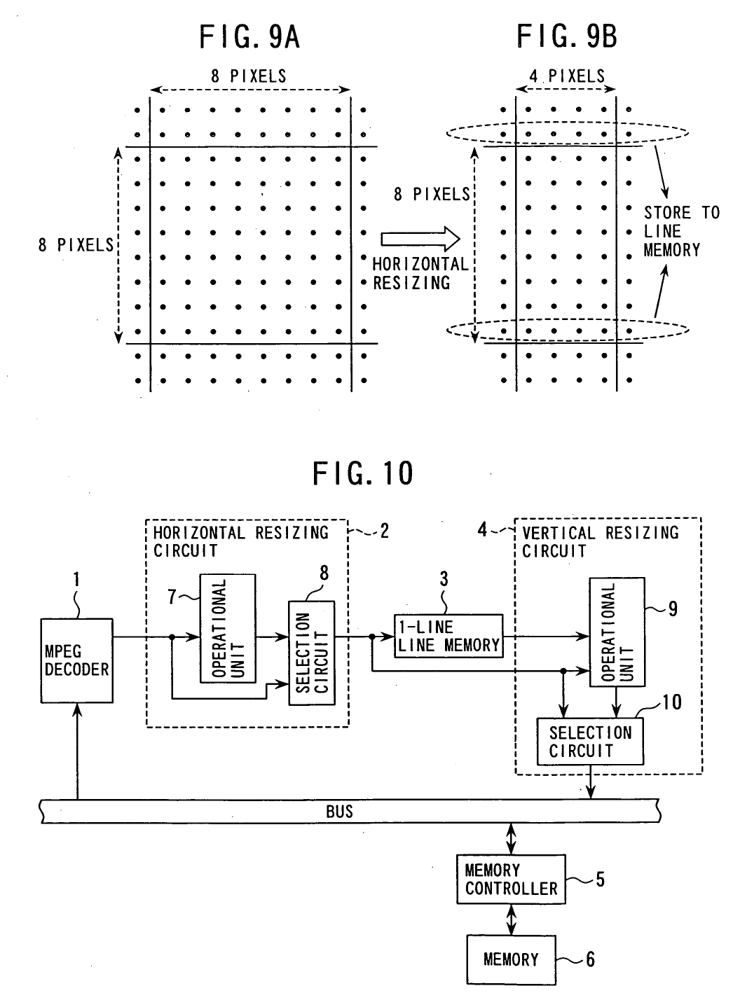

FIGS. 9A and 9B show the block sizes before and after the horizontal resizing processing in the present embodiment. FIG. 9A shows the block size outputted by the MPEG decoder 1, and FIG. 9B shows the block size to be outputted by the horizontal resizing circuit 2. While, as shown in FIG. 9A, 8×8 pixels are treated as one block at the MPEG decoder 1, the block size is changed to 4×8 pixels by the means of the resizing at the horizontal resizing circuit 2 as shown in FIG. 9B where the data of the lowest line thereof are stored to the line memory 3 as indicated. Note that it is also possible to maintain the 8×8 block size after the horizontal resizing by reducing the number of blocks in the horizontal direction to one half.

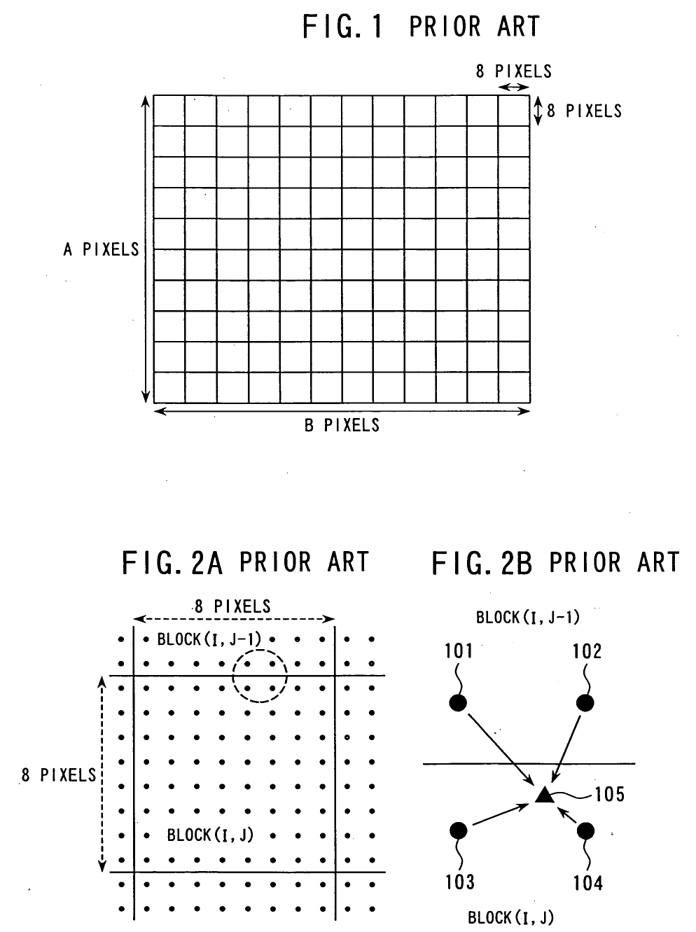

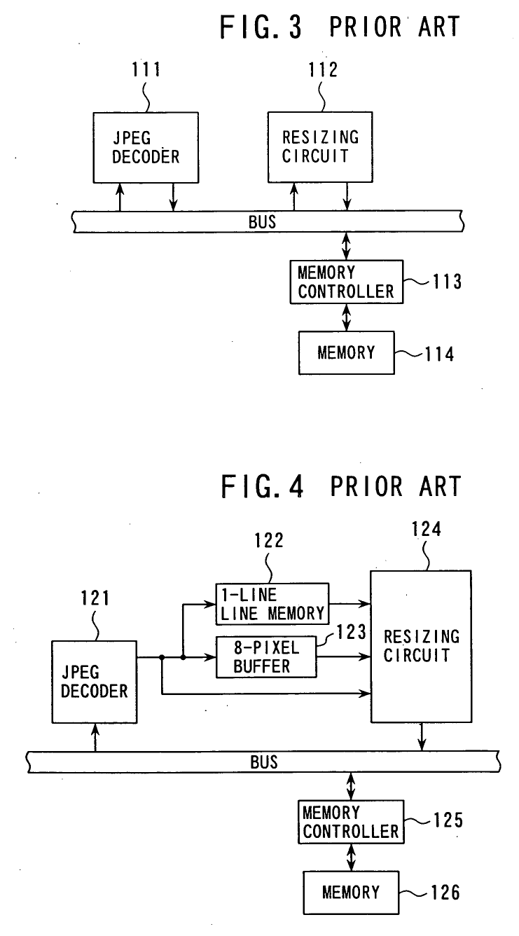

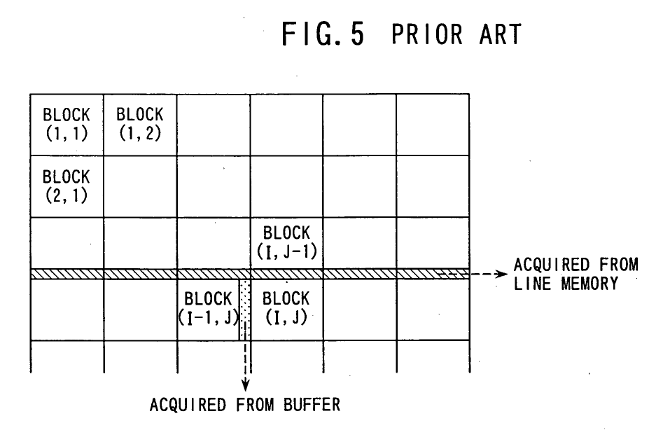

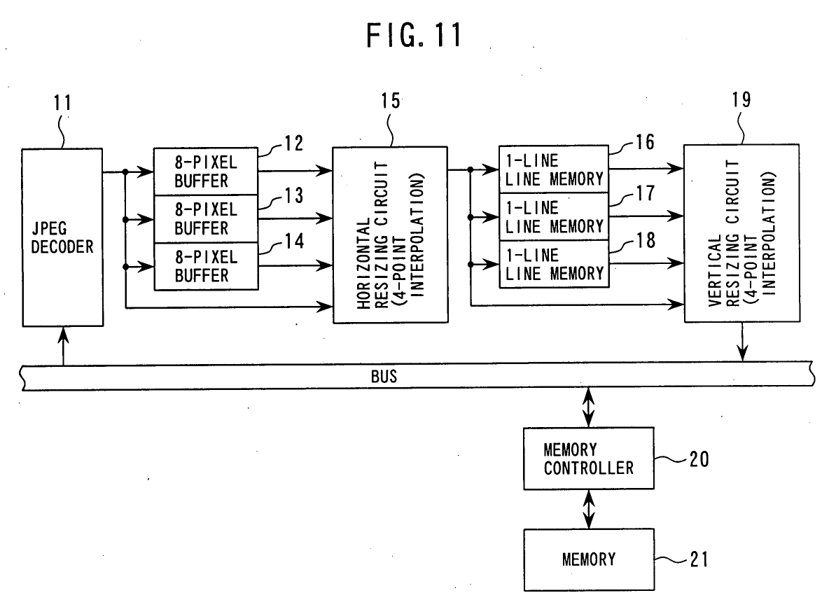

FIG. 10 is a block diagram showing a modification of the present embodiment. Referring to FIG. 10, the horizontal resizing circuit 2 is provided with a selection circuit 8 in addition to an operational unit 7 for effecting the horizontal resizing, and the vertical resizing circuit 4 is provided with a selection circuit 10 in addition to an operational unit 9 for effecting the vertical resizing. The construction of other portions thereof is similar to FIG. 1. In thus constructed modification, one or both of the resizing functions at the horizontal resizing circuit 2 and vertical resizing circuit 4 can be caused to be through without a processing operation by the means of the selection circuits 8, 10.

According to the present embodiment, the image data can be resized block by block. It is in addition possible to achieve the resizing with a smaller line memory capacity as compared to the conventional example, since the image data after the resizing in the horizontal direction is stored to the line memory. Further, since the resizing circuit is divided into one for the horizontal direction and one for the vertical direction, it becomes easier to correspond to the cases where the reducing or enlarging rate or the resizing technique is different between the horizontal direction and the vertical direction.

### Second Embodiment

FIG. 11 is a block diagram showing the construction of an image processing apparatus according to a second embodiment of the invention. FIG. 11 includes: 11, JPEG decoder for decoding the JPEG code data to output image data by the unit block of 8×8 pixel size; 12 to 14, buffers each having a capacity corresponding to eight pixels for storing image data outputted block by block from the JPEG decoder 11; 15, a horizontal resizing circuit for effecting resizing in the horizontal direction by using the output data from the JPEG decoder 11 and data stored to the buffers 12 to 14; 16 to 18, line memories each having a capacity corresponding to one line for storing line by line the output data of the horizontal resizing circuit 15; 19, a vertical resizing circuit for effecting a resizing in the vertical direction by using the output data of the horizontal resizing circuit 15 and data stored to the line memories 16 to 18; 20, a memory controller; and 21, a memory.

A description will now be given with respect to the horizontal resizing technique in thus constructed second embodiment. The horizontal resizing method in the first embodiment is an added average method as shown in FIG. 8A or a simple thinning-out/insertion method as shown in FIG. 8B, where a buffer for acquiring image information of a horizontally adjacent block is unnecessary. In the present embodiment, a 4-point interpolation method as shown in FIG. 8D is used as the horizontal resizing method so that it is provided with the three buffers 12 to 14 for acquiring image information of the horizontally adjacent block.

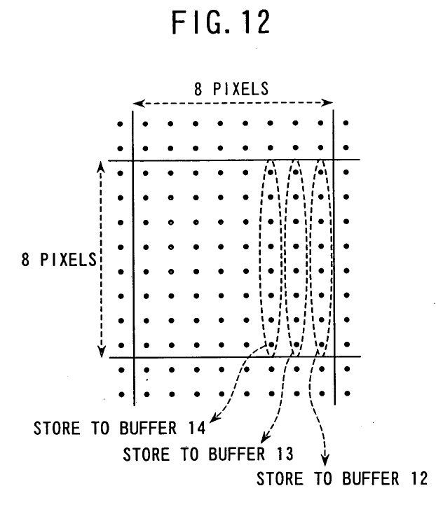

FIG. 12 illustrates the method of storage to the three buffers 12 to 14 in the present embodiment. Of the image data outputted block by block from the JPEG decoder 11, the eight pixels of the rightest column within the 8×8 pixel block are stored to the buffer 12, the eight pixels of the second column from the right to the buffer 13, and the eight pixels of the third column from the right to the buffer 14. The horizontal resizing of the 4-point interpolation method requires information corresponding to four pixels, and it is necessary at a block peripheral portion to acquire information corresponding to a maximum of three pixels from the adjacent block. The horizontal resizing circuit 15 acquires pixel information from the buffers 12 to 14 as required to effect the horizontal resizing. It should be noted that, if a 2-point interpolation method as shown in FIG. 8C is used as the resizing method at the horizontal resizing circuit 15, the present embodiment as shown in FIG. 11 may be constructed with omitting the buffer 13 and buffer 14.

A vertical resizing technique will now be described. The vertical resizing method in the first embodiment uses the 2-point interpolation method as shown in FIG. 8C and is provided with one line memory. In the present embodiment, the vertical resizing method uses a 4-point interpolation method as shown in FIG. 8D, and a total of three line memories, i.e., the line memories 16 to 18 are provided. Of the output data of the horizontal resizing circuit 15, the pixel data of the lowest line of the block are stored to the line memory 16, the pixel data of the second line from bottom to the line memory 17, and the pixel data of the third line from bottom to the line memory 18. The vertical resizing circuit 19 becomes capable of the vertical resizing based on the 4-point interpolation method by acquiring pixel information from the line memories 16 to 18 as required.

According to the present embodiment, additional buffers and line memories for acquiring information of the adjacent block are provided as compared to the first embodiment. For this reason, it is possible to apply the horizontal resizing method and vertical resizing method of a higher level as compared to the first embodiment so that a high quality output image can be obtained. Further, since, according to the present invention, the capacity of line memory can be saved as compared to the conventional example, an increase in the circuit size can be controlled as compared to the conventional example even when the number of line memories is increased as in the present embodiment.

### Third Embodiment

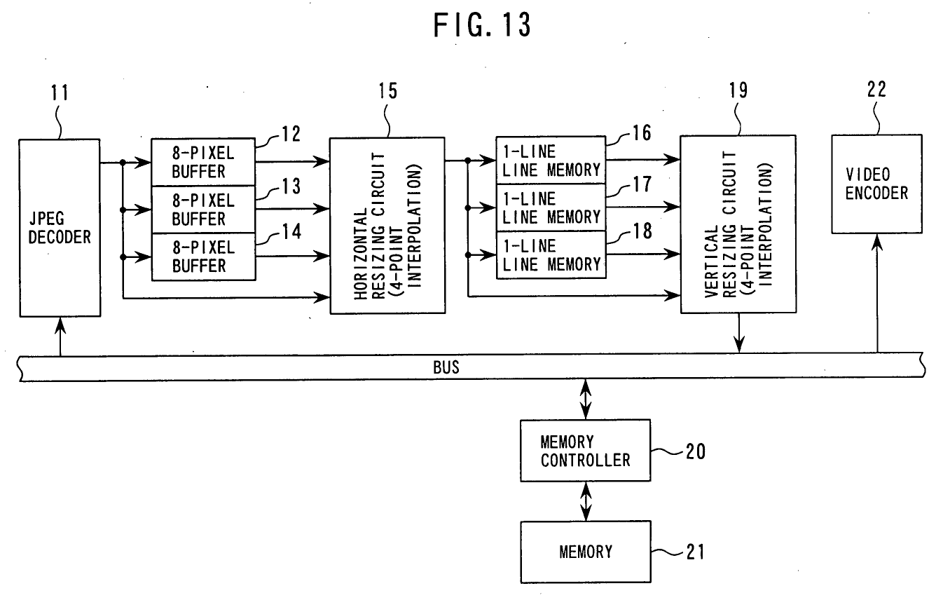

FIG. 13 is a block diagram showing the construction of an image processing apparatus according to a third embodiment of the invention. The construction of this embodiment except the providing of a video encoder 22 is similar to the second embodiment and will not be described. The video encoder 22 is for outputting data to an external image display apparatus by acquiring via the memory controller 20 the image data after the resizing processing which is stored to the memory 21. It should be noted that line memories 16 to 18 in the present embodiment are characterized in their capacity corresponding to an effective region of the external display apparatus. For example, if the size of the effective region of the external image display apparatus is 720×480, it is supposed that each of the line memories 16 to 18 has a capacity corresponding to 720 pixels.

A description will now be given with respect to the case of reducing a 2048×1536 pixel size image to 720×480 pixels and the case of enlarging a 320×240 pixel size image to 720×480 pixels. If the pixel size decoded at the JPEG decoder 11 is 2048×1536, the horizontal resizing circuit 15 effect a reduction processing to output image data of 720 ×1536 size. An image data of 720 pixels is stored to each of the line memories 16 to 18 so that image data of 720×480 size is obtained at the vertical resizing circuit 19.

If the pixel size decoded at the JPEG decoder 11 is 320×240, on the other hand, the horizontal resizing circuit 15 effects an enlarging processing to output image data of 720×240 size. An image data of 720 pixels is stored to each of the line memories 16 to 18 so that image data of 720×480 size is obtained at the vertical resizing circuit 19.

In the cases as described where the effective region of the external image display apparatus is 720×480, it is seen that a capacity capable of storing 720 pixels suffices for the line memories 16 to 18, since the width of the image after the horizontal resizing processing becomes 720 pixels.

According to the present embodiment, since the capacity of the line memory is determined in accordance with the display region of the external image display apparatus, it is possible to efficiently use the line memory irrespective of the enlarging rate or reducing rate of the resizing processing.

### Fourth Embodiment

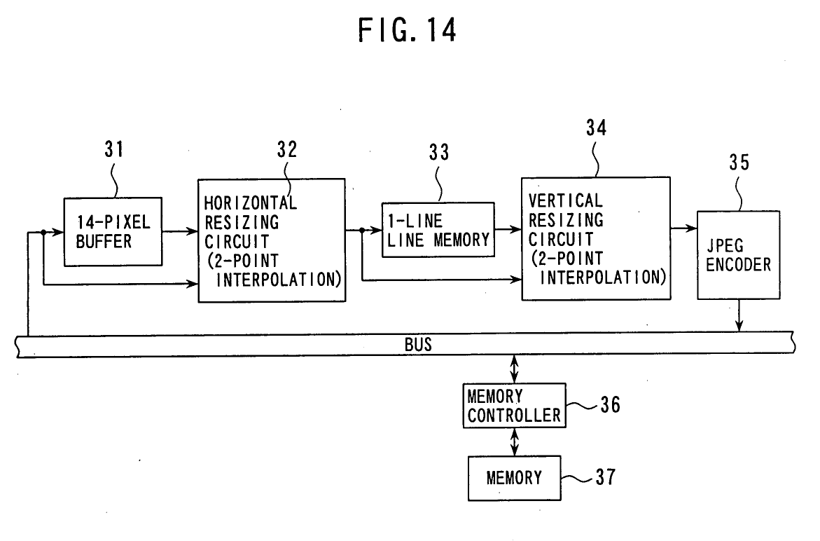

FIG. 14 is a block diagram showing the construction of an image processing apparatus according to a fourth embodiment of the invention. FIG. 14 includes: 31, a buffer having a capacity corresponding to the pixels in the vertical direction of block of the image data inputted block by block; 32, a horizontal resizing circuit for resizing the block-by-block inputted image data in the horizontal direction; 33, a line memory having a capacity corresponding to one line for storing the data of the lowest line of the output data of the horizontal resizing circuit 32; 34, a vertical resizing circuit for resizing the output data of the horizontal resizing circuit 32 in the vertical direction; 35, JPEG encoder for encoding the output data of the vertical resizing circuit 34 into the JPEG code data; 36, a memory controller; and 37, a memory.

The present embodiment will be described below with respect to the case where an input image of 720×480 pixels is reduced to 352×288 pixels and then encoded into the JPEG code data. It is supposed that the JPEG encoding is to be effected by the unit block of 8×8 pixel.

The operation of the present embodiment will now be described. The image data stored at the memory 37 is inputted via the memory controller 36 to the buffer 31 and to the horizontal resizing circuit 32. At this time, the image data from the memory 37 is read by the block of N×M pixels, and the pixel number N in the horizontal direction and the pixel number M in the vertical direction are determined by the enlarging or reducing rate. In this case, for example, N is determined as 16 or 17 and M as 13 or 14.

Of the data read out block by block from the memory 37, the pixels of the rightest column of the N×M pixels are stored to the buffer 31. Since the maximum of the input block size in the present embodiment is 17×14 pixels, the buffer 31 is provided with a capacity corresponding to 14 pixels. The horizontal resizing circuit 32 resizes the N×M pixel block in the horizontal direction to generate a block of 8×M pixels. At this time, information of adjacent block is acquired from the buffer 31 and the horizontal resizing is achieved by 2-point interpolation operation.

Of the data outputted at the horizontal resizing circuit 32, the pixel information of the lowest line of block is stored to the line memory 33. The line memory 33 has a capacity corresponding to 352 pixels. The vertical resizing circuit 34 uses the output data of the horizontal resizing circuit 32 and the data stored to the line memory 33 to effect a vertical resizing based on 2-point interpolation operation. The block size to be inputted to the vertical resizing circuit 34 is 8×M pixels, and the output block size therefrom is 8×8 pixels. The image data outputted from the vertical resizing circuit 34 is subjected to the JPEG coding at the JPEG encoder 35 and is stored to the memory 37 via the memory controller 36.

While the techniques for resizing after decoding have been described in the first to third embodiments, it is also possible according to the present embodiment to perform the coding after the block-by-block resizing. Further, similarly to the first and second embodiments, since the image data after being resized in a first direction is stored to the line memory, the resizing can be achieved with a smaller line memory capacity as compared to the conventional example.

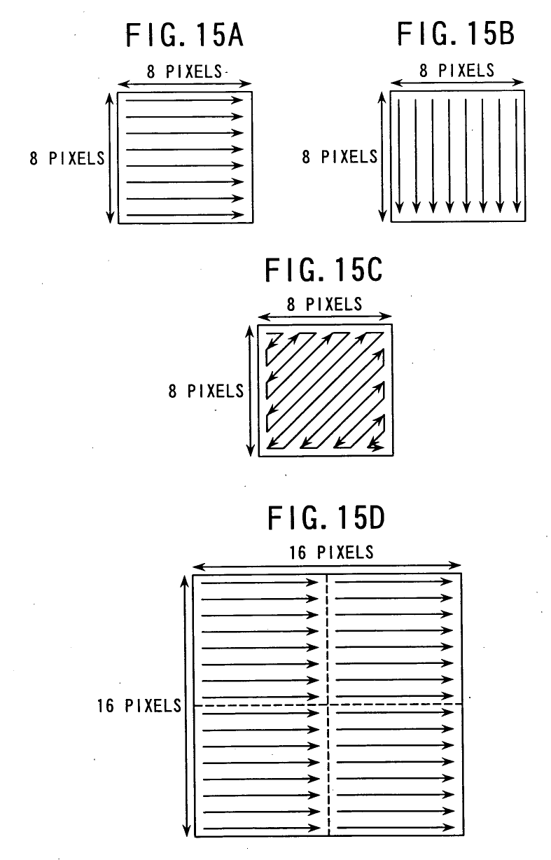

FIGS. 15A to 15D show examples of data output sequence by the block. The data output sequence in the above described first to fourth embodiments is capable of corresponding for example to any data output sequence of FIGS. 15A, 15B, 15C. Also, the block size includes but naturally not limited to 8×8 pixel size and it is also possible to effect processing by forming a unit for example by a 16×16 size macro block as shown in FIG. 15D obtained by gathering a plurality (4 in the illustrated example) of blocks of 8×8 pixel size.

While the descriptions in the above first to fourth embodiments have been made with respect to the cases of application to the JPEG and MPEG, the image compression/expansion method in each embodiment is not specifically limited and the JPEG, MPEG, H261 and other image compression/expansion methods can be used.

As has been described by way of the above embodiments, since, according to the first aspect of the invention, image data can be resized block by block and the image data after its resizing in a first direction is stored to a line storage means, the resizing processing can be effected with the line storage means having a relatively small capacity. According to the second aspect, since image data is to be resized block by block, the image data decoded block by block at the decoding means can be resized by each of the blocks as they are. According to the third aspect, since image data is processed block by block, the image data resized block by block can be encoded by each of the blocks as they are. According to the fourth and fifth aspects, since the first resizing means effects resizing in a first direction based on a thinning out or added average, the resizing in the first direction can be executed with a simple construction. According to the sixth aspect, image data of adjacent block can be used in the resizing in a first direction so that a high-level resizing can be effected.

According to the seventh aspect, since pixel storage means corresponding to one column is provided so as to be able to store data corresponding to one column of adjacent block, the first resizing means becomes capable of a resizing based on 2-point interpolation. According to the eighth aspect, since pixel storage means corresponding to three columns is provided so as to be able to store data corresponding to three columns of adjacent block, the first resizing means becomes capable of a resizing based on 4-point interpolation. According to the ninth aspect, since line storage means corresponding to one line is provided so as to be able to store data corresponding to one line of adjacent block, the second resizing means becomes capable of 2-point interpolation. According to the tenth aspect, since line storage means corresponding to three lines is provided so as to be able to store data corresponding to three lines of adjacent block, the second resizing means becomes capable of 4-point interpolation. According to the eleventh aspect, since a first through resizing means is provided, it is possible to selectively cause the resizing in a first direction to be through without a processing operation. According to the twelfth aspect, since a second through resizing means is provided, it is possible to selectively cause the resizing in a second direction to be through without a processing operation. According to the thirteenth aspect, since the line storage means has a capacity corresponding to the display region of an external display apparatus, the line storage means can be efficiently used irrespective of the enlarging rate or reducing rate.

What is claimed is:

1. An image processing apparatus taking N×M pixels (N, M being a natural number of 2 or more) as one block, for processing image data consisting of a plurality of blocks by the unit block, said image processing apparatus comprising:
a first resizing means for resizing said image data in a first direction;
a line storage means capable of storing at least image data corresponding to one line along the first direction of the image data outputted from the first resizing means; and
a second resizing means for resizing the image data outputted from said first resizing means in a second direction intersecting the first direction,
wherein said second resizing means is formed so as to acquire image data of adjacent block from said line storage means.

2. The image processing apparatus according to claim 1 further comprising a decoding means for decoding compressed and encoded image data block by block, the image data decoded at the decoding means being subjected to the resizing.

3. The image processing apparatus according to claim 1 further comprising an encoding means for compressing and encoding image data block by block, the resized image data being compressed and encoded at said encoding means.

4. The image processing apparatus according to claim 1, wherein said first resizing means resizes said image data based on a thinning out in the first direction.

5. The image processing apparatus according to claim 1, wherein said first resizing means resizes said image data based on an added average in the first direction.

6. The image processing apparatus according to claim 1 further comprising a pixel storage means capable of storing at least image data corresponding to the number of pixels of block in the second direction of said N×M pixel block, said first resizing means acquiring image data of adjacent block from said pixel storage means.

7. The image processing apparatus according to claim 6, wherein said pixel storage means is capable of storing image data corresponding to the number of pixels of block in the second direction of the N×M pixel block, and said first resizing means effects resizing based on 2-point interpolation in the first direction.

8. The image processing apparatus according to claim 6, wherein said pixel storage means is capable of storing image data corresponding to three times the number of pixels of block in the second direction of the N×M pixel block, and said first resizing means effects resizing based on 4-point interpolation in the first direction.

9. The image processing apparatus according to claim 1, wherein said line storage means is capable of storing image data corresponding to one line in the first direction of the image data resized at said first resizing means, and said second resizing means effects resizing based on 2-point interpolation in the second direction.

10. The image processing apparatus according to claim 1, wherein said line storage means is capable of storing image data corresponding to three lines in the first direction of the image data resized at said first resizing means, and said second resizing means effects resizing based on 4-point interpolation in the second direction.

11. The image processing apparatus according to claim 1 further comprising a first through resizing means capable of causing the resizing in the first direction to be through without a processing operation.

12. The image processing apparatus according to claim 1 further comprising a second through resizing means capable of causing the resizing in the second direction to be through without a processing operation.

13. The image processing apparatus according to claim 11 further comprising a second through resizing means capable of causing the resizing in the second direction to be through without a processing operation.

14. The image processing apparatus according to claim 1, wherein said line storage means has a capacity corresponding to a display region of an external display apparatus.
